(19) United States
(12) Patent Application Publication
(10) Pub. No.: US 2016/0064943 A1
(43) Pub. Date: Mar. 3, 2016

(54) CONTROLLING METHOD AND SYSTEM OF POWER TRANSMISSION SYSTEM

(71) Applicants: Hyundai Motor Company, Seoul (KR); Konkuk University Industrial Cooperation Corp., Seoul (KR)

(72) Inventors: Hyunchul Ku, Seoul (KR); Jaeyong Seong, Anyang (KR); Wonshil Kang, Seoul (KR); Jonggyun Lim, Seoul (KR)

(73) Assignees: Konkuk University Industrial Cooperation Corp.; Hyundai Motor Company

(21) Appl. No.: 14/562,695

(22) Filed: Dec. 6, 2014

(30) Foreign Application Priority Data
Aug. 28, 2014 (KR) 10-2014-0113254

(51) Int. Cl. H02J 5/00; H04B 5/00

(52) U.S. Cl. CPC H02J 5/005; H04B 5/0037

(57) ABSTRACT

A controlling method and system for a power transmission system are provided. The method includes matching phases and amplitudes of multiple transmission signals to be output from multiple transmitter coils and separating the multiple transmission signals of which phases and amplitudes have been matched. The separated transmission signals are then transmitted to a receiver coil and power transmission efficiency is measured. In addition, the method includes adjusting phases and amplitudes of the multiple transmission signals based on the measured power transmission efficiency.

### CROSS REFERENCE TO RELATED APPLICATION

The present application claims priority of Korean Patent Application Number 10-2014-0113254 filed on Aug. 28, 2014, the entire contents of which application are incorporated herein for all purposes by this reference.

### BACKGROUND

1. Field of the Invention

The present invention relates, generally, to a controlling method and system of a power transmission system and, more particularly, to a controlling method of a power transmission system that controls phase and amplitude of transmission signals output from multiple transmitter pads.

2. Description of the Related Art

Wireless power transmission is commonly performed using magnetic induction, magnetic resonance, RF, laser, and the like. Magnetic induction is commonly used in products such as an electric toothbrush, a wireless electric kettle, etc. Magnetic induction maintains an efficiency of over 90% at close distances, but as the distance increases the efficiency rapidly decreases.

Meanwhile, magnetic resonance is a highly efficient method for wireless power transmission and can transmit power to range from several centimeters to several meters, which is substantial compared to magnetic induction. However surrounding obstacles, metal materials, or debris may change a magnetic resonance characteristic, and thus power transmission efficiency decreases rapidly. Consequently, it is required to additionally control factors including frequency, coupling coefficient, and the like.

Additionally, since magnetic resonance has different operating methods for high power transmission and high efficiency, multiple transmitting sets may be required to satisfy the output power level that a receiver requests. In other words, when a transmitter-receiver block cannot transmit enough power requested by the receiver, multiple transmitting sets may be required. However, there are some cases where using multiple transmitting sets causes a decrease in efficiency, therefore a method for improving efficiency is necessary.

### SUMMARY

Accordingly, the present invention provides a controlling method of a power transmission system that may achieve maximum power transmission efficiency by adjusting phase and amplitude of transmission signals output from multiple transmitter pads.

A controlling method of a power transmission system according to an exemplary embodiment of the present invention may include matching phases and amplitudes of multiple transmission signals to be output respectively from multiple transmitter coils; separating the multiple transmission signals of which phases and amplitudes have been matched, and transmitting the separated transmission signals to a receiver coil; receiving the transmission signals and measuring power transmission efficiency; and adjusting phases and amplitudes of the multiple transmission signals based on the measured power transmission efficiency.

The process of matching phases and amplitudes may include setting a transmission signal of one transmitter coil among the multiple transmitter coils to a reference signal. In addition, the process of matching phases and amplitudes may include extracting a phase difference between transmission signals by calculating a cross-correlation between the reference signal and transmission signals from the other transmitter coils. The process of matching phases and amplitudes may further include matching phases of the transmission signals by adjusting the extracted phase difference.

Further, the process of matching phases and amplitudes may include transmitting transmission signals from multiple transmitter coils to a receiver coil using earlier signals that have different frequencies. The carrier signals may be removed from the signals that have been transmitted to the receiver coil, and a phase difference may be extracted between the transmission signals. In addition, the phases of the transmission signals may be matched by adjusting the extracted phase difference.

The process of measuring power transmission efficiency may include measuring power transmission efficiency with increasing or decreasing amplitude and phase of a transmission signal from a respective transmitter coil. The process of adjusting phase and amplitude of the multiple transmission signals may include setting phase and amplitude to those in which the measured power transmission efficiency is a highest. The controlling method of a power transmission system may further include storing the adjusted phase and amplitude and a vehicle identification number that corresponds to the phase and amplitude.

A vehicle identification number may be detected, and when the identification number is a stored number, phase and amplitude of the multiple transmission signals may be adjusted to be a phase and amplitude that correspond to the vehicle identification number. The controlling method of a power transmission system may further include observing vehicle surroundings using capturing devices (e.g., imaging devices, sensors, or the like) in a front part and an upper part of the vehicle before transmitting the transmission signals to a receiver coil.

A controlling method of a power transmission system according to an exemplary embodiment of the present invention may thus control phase and amplitude of a respective transmission signal by synchronizing transmission signals output from multiple transmitters. The method may also increase power transmission efficiency by adjusting amplitude and phase of each of the multiple transmission signals. The method may also improve safety in the process of power transmission.

### BRIEF DESCRIPTION OF THE DRAWINGS

The above and other features of the present invention will now be described in detail with reference to various exemplary embodiments thereof illustrated the accompanying drawings which are given hereinbelow by way of illustration only, and thus are not limitative of the present invention, and wherein:

FIG. 1 is an exemplary view of a power transmission system according to one exemplary embodiment of the present invention;

FIG. 2 is an exemplary flow diagram for a controlling method of a power transmission system according to one exemplary embodiment of the present invention;

FIG. 3 is an exemplary flow diagram for a method to match phases of transmission signals according to one exemplary embodiment of the present invention;

FIG. 4 is an exemplary flow diagram for a method to match phases of transmission signals according to another exemplary embodiment of the present invention;

FIG. 5 is an exemplary view showing positions of a transmitter coil and receiver coil according to one exemplary embodiment of the present invention;

FIG. 6 is an exemplary graph of a phase difference of transmission signals from transmitter coils, output power on a receiver coil, and transmission efficiency in which the transmitter coils and receiver coil are disposed as FIG. 5 according to an exemplary embodiment of the present invention;

FIG. 7 is an exemplary view showing phase and amplitude of transmission signals in QAM mode according to an exemplary embodiment of the present invention.

FIG. 8 is an exemplary view showing variance in phase and amplitude of a transmission signal according to one exemplary embodiment of the present invention;

FIG. 9 is an exemplary view showing an increase in the number of axes as the number of transmitter coils increases according to an exemplary embodiment of the present invention;

FIG. 10 is an exemplary flow diagram of a controlling method of a power transmission system according to one exemplary embodiment of the present invention;

FIG. 11 is an exemplary block diagram illustrating a relation between components of the power transmission system shown in FIG. 1 according to an exemplary embodiment of the present invention;

FIG. 12 is an exemplary flow diagram of a part of a controlling method of a power transmission system according to one exemplary embodiment of the present invention; and

FIG. 13 is an exemplary view showing a configuration and input/output of a transmission circuit according to one exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/controller refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”

Specific structural or functional descriptions in the exemplary embodiments of the present invention disclosed in the specification or application are only for description of the exemplary embodiments of the present invention, can be embodied in various forms and should not be construed as limited to the embodiments described in the specification or application.

Specific exemplary embodiments are illustrated in the drawings and described in detail in the specification or application because the exemplary embodiments of the present invention may have various forms and modifications. It should be understood, however, that there is no intent to limit the embodiments of the present invention to the specific embodiments, but the intention is to cover all modifications, equivalents, and alternatives included to the scope of the present invention. Although the terms first, second, etc. may be used herein to describe various elements, these elements should not be limited by these terms. These terms are used to distinguish one element from another. For example, a first element could be termed a second element, and, similarly, a second element could be termed a first element, without departing from the scope of the present invention.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Reference now should be made to the drawings, in which the same reference numerals are used throughout the different drawings to designate the same or similar components.

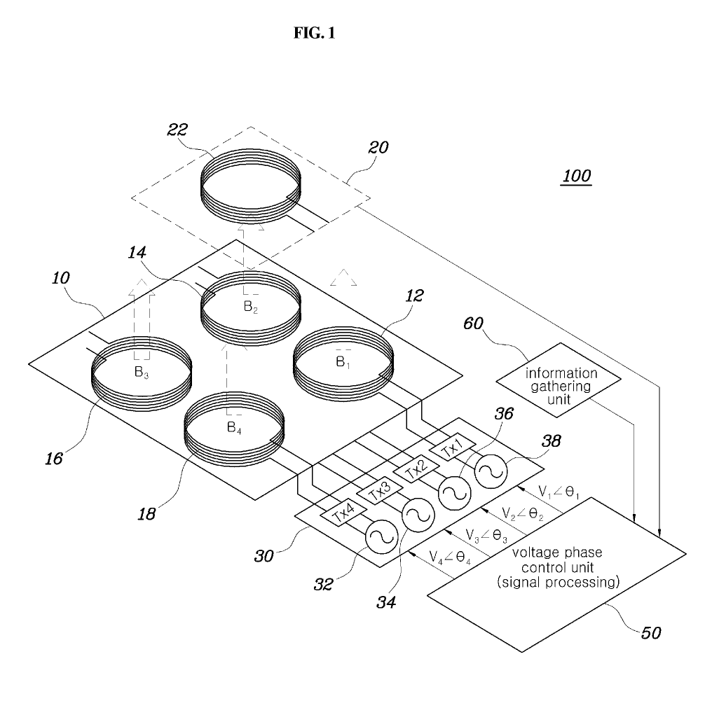

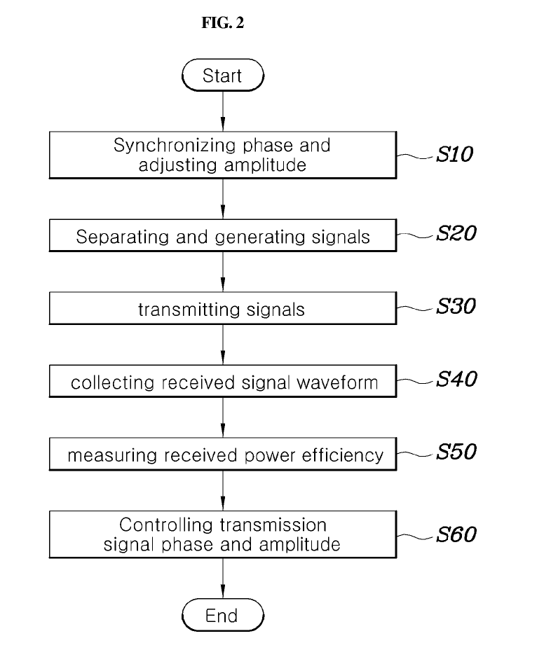

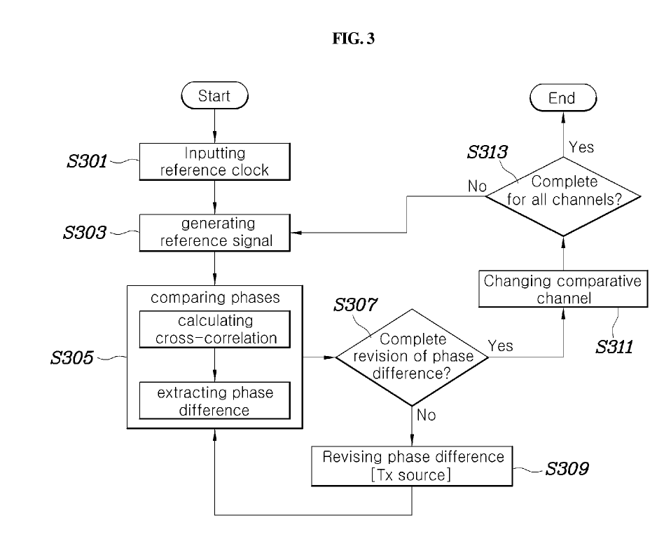

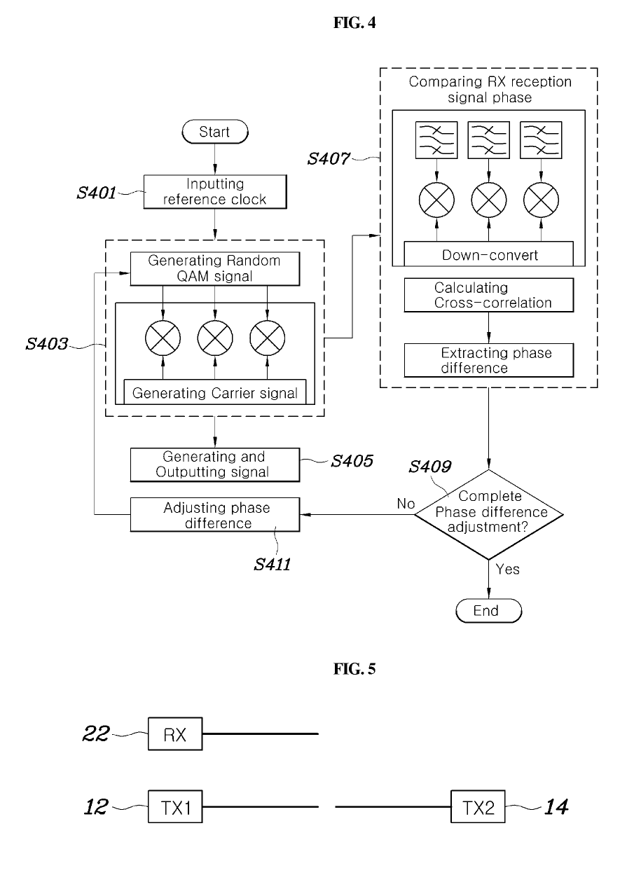

FIG. 1 is an exemplary view of a power transmission system according to one exemplary embodiment of the present invention, and FIG. 2 is an exemplary flow diagram for a controlling method of a power transmission system according to one exemplary embodiment of the present invention. FIG. 3 is an exemplary flow diagram for a method to match phases of transmission signals according to one exemplary embodiment of the present invention, and FIG. 4 is an exemplary flow diagram for a method to match phases of transmission signals according to another exemplary embodiment of the present invention.

Referring to FIGS. 1 to 4, a power transmission system according to one exemplary embodiment of the present invention may include a transmitter pad 10 containing multiple transmitter coils 12, 14, 16, 18; a receiver pad 20 containing at least one receiver coil 22; a transmission circuit array 30 configured to adjust phase and amplitude of transmission signals output from the transmitter coils 12, 14, 16, 18 and supply charging power from charging power supply units 32, 34, 36, 38 to the transmitter coils 12, 14, 16, 18; a voltage phase controller 50 configured to adjust phase and amplitude of the charging power supplied from the charging power supply units 32, 34, 36, 38 and receive the receive voltage/current waveforms and receive power information from the receiver pad 20; and an information gathering unit 60 configured to transmit a vehicle identification number and information regarding the vehicle surroundings (e.g., environment in the vicinity of the vehicle) to the voltage phase controller 50.

A controlling method of a power transmission system according to an exemplary embodiment of the present invention may include matching, by a controller, phases and amplitudes of multiple transmission signals to be output respectively from multiple transmitter coils 12, 14, 16, 18 (S10), separating, by the controller, the multiple transmission signals of which phases and amplitudes have been matched, and transmitting the separated transmission signals to a receiver coil (S20, S30), receiving, by the controller, the transmission signals and measuring power transmission efficiency (S40, S50), and adjusting, by the controller, phases and amplitudes of multiple transmission signals based on the measured power transmission efficiency (S60).

The process of matching phases and amplitudes of multiple transmission signals (S10) may include setting, by the controller, a reference signal to a transmission signal of one transmitter coil among multiple transmitter coils 12, 14, 16, 18 (S301, S303), extracting, by the controller, a phase difference between transmission signals by calculating cross-correlation between the reference signal and transmission signals of the other transmitter coils (S305), and matching, by the controller, phases of the transmission signals by adjusting the extracted phase difference (S307-S313).

For example, when a transmission signal of a first transmitter coil 12 is set to a reference signal, a phase difference of transmission signals to be transmitted to a receiver coil respectively from the first transmitter coil 12 and a second transmitter coil 14 may be determined by calculating cross-correlation of the transmission signals. Thus, the phase difference of the transmission signals from the first transmitter coil 12 and the second transmitter coil 14 may be extracted and adjusted. After the adjustment process, a comparative channel may be changed, and a phase difference of transmission signals to be transmitted to the receiver coil respectively from the first transmitter coil 12 and a third transmitter coil 16, may be determined by calculating cross-correlation of the transmission signals. Consequently, after the phase difference is adjusted based on the calculated cross-correlation, the comparative channel may be changed again and a phase difference of transmission signals from the first transmitter coil 12 and a fourth transmitter coil 18 may be adjusted, and when the adjustment for all the channels is completed, the transmission signals may be transmitted to the receiver coil 22.

Moreover, the process of matching phases and amplitudes of multiple transmission signals (S10) may include transmitting, by the controller, transmission signals from multiple transmitter coils 12, 14, 16, 18 to a receiver coil 22 using carrier signals of different frequencies (S401, S403, S405), removing, by the controller, the carrier signals from the signals transmitted to the receiver coil 22 and extracting a phase difference between the transmission signals (S407), and matching, by the controller, phases of the transmission signals by adjusting the extracted phase difference (S409, S411). In other words, a signal for respective paths from transmitter coils to a receiver coil may be set to a frequency, and a baseband signal of the respective path may be extracted using a digital filter at a receiver pad 20. Subsequently, amplitudes and phases of the respective baseband signals may be compared, and thus the difference of phases and amplitudes in the multiple paths may be compensated for.

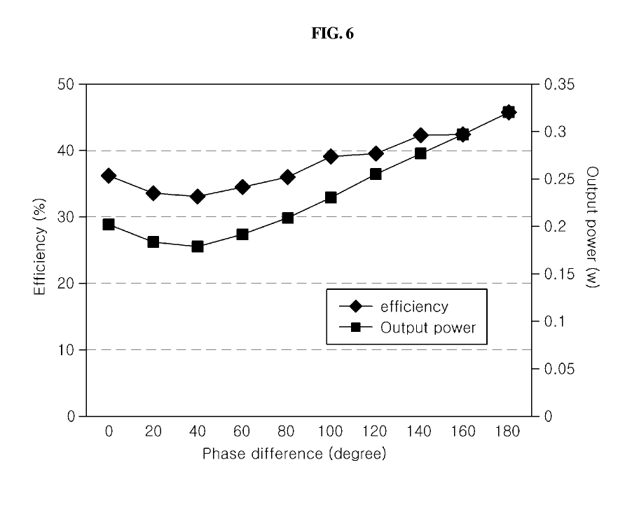

FIG. 5 is an exemplary view showing positions of a transmitter coil and receiver coil according to one exemplary embodiment of the present invention, and FIG. 6 is an exemplary graph of a phase difference of transmission signals from transmitter coils, output power on a receiver coil, and transmission efficiency in which the transmitter coils and receiver coil are disposed as FIG. 5.

Referring to FIGS. 5-6, under the assumption that center points of a receiver coil 22 and a first transmitter coil 12 are arranged on a perpendicular line, when the phase difference between the transmission signal from the first transmitter coil 12 and the transmission signal from the second transmitter coil 14 is about 180 degrees, the power transmission efficiency may have a maximum value and the output power may be at a highest. This case is an example in which a transmitter coil of a transmitter pad 10 may be composed of the first transmitter coil 12 and the second transmitter coil 14. As shown FIG. 6, the power transmission efficiency on a receiver pad 20 may be different based on changes in phase and amplitude of the transmission signals. Additionally, according to the positions of the receiver coil 22 and transmitter coils 12, 14, 16, 18, the amplitude and phase difference of the transmission signals output from the transmitter coils 12, 14, 16, 18 may be varied to achieve a highest power transmission efficiency.

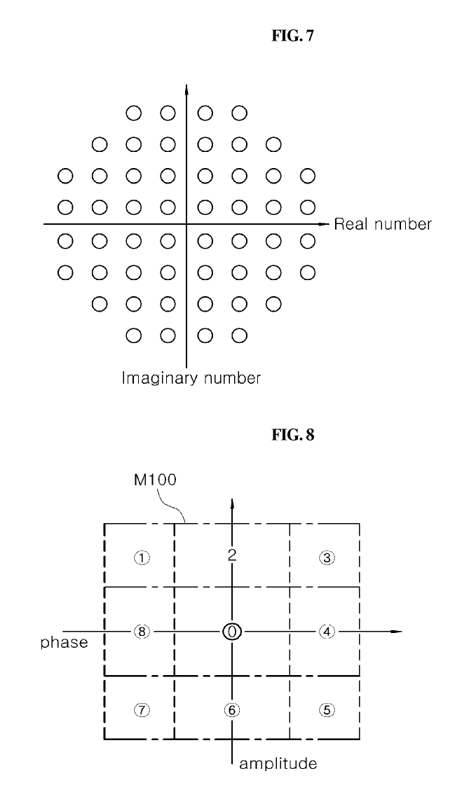

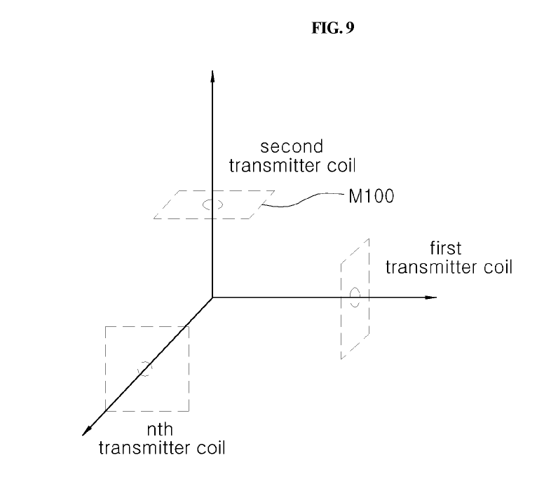

FIG. 7 is an exemplary showing phase and amplitude of transmission signals in quadrature amplitude modulation (QAM) mode and FIG. 8 is an exemplary view showing variance in phase and amplitude of a transmission signal according to one exemplary embodiment of the present invention. FIG. 9 is an exemplary view showing an increase in the number of axes as the number of transmitter coils increases. As shown in FIG. 7, phase and amplitude of transmission signals traveling along respective paths from the transmitter coils to the receiver coil may be varied. The view in FIG. 7 is a QAM mode and is an example in which a most efficient amplitude and phase of the transmission signals for each path are described. To charge power from the transmitter coils for the first time, amplitudes and phases of the transmission signals from the respective transmitter coils may be matched for each path. For example, charging may be started in which amplitudes of the transmission signals have been matched to be about 50% of the maximum value and phases of those have been matched to be about 0 degrees.

As shown in FIG. 8, when there are a phase axis and an amplitude axis, the number of cases for increasing or decreasing in phase and amplitude is represented as 9 cases including origin point of the phase and amplitude in which charging is started. This represents a case for each transmitter coil, and when the number of transmitter coils is two, the case may be represented to total 80 cases using a calculation like 9*9−1. When the number of transmitter coils on a transmitter pad is N, the number of cases is calculated by 9̂N−1. As shown in FIG. 9, the number of axes and cases may increase with an increase in the transmitter coils. A degree of increasing or decreasing phase and amplitude may be set optionally, and the convergence rate may vary based on the amplitude.

In each case, transmission signals may be bundled and transmitted sequentially similar to a method of transmitting signals in QAM, and power transmission efficiency may be measured for each case. Further, amplitude and phase of the bundled transmission signals with the highest transmission efficiency may be selected. While the power transmission efficiency is measured by increasing or decreasing phase and amplitude of a transmission signal from respective transmitter coils, adjusting the phase and amplitude of the transmission signal may be performed by the controller repeatedly until no further increase in power transmission efficiency is measured. In other words, phase and amplitude of multiple transmission signals may be set to where the power transmission efficiency on the receiver pad 20 is a highest.

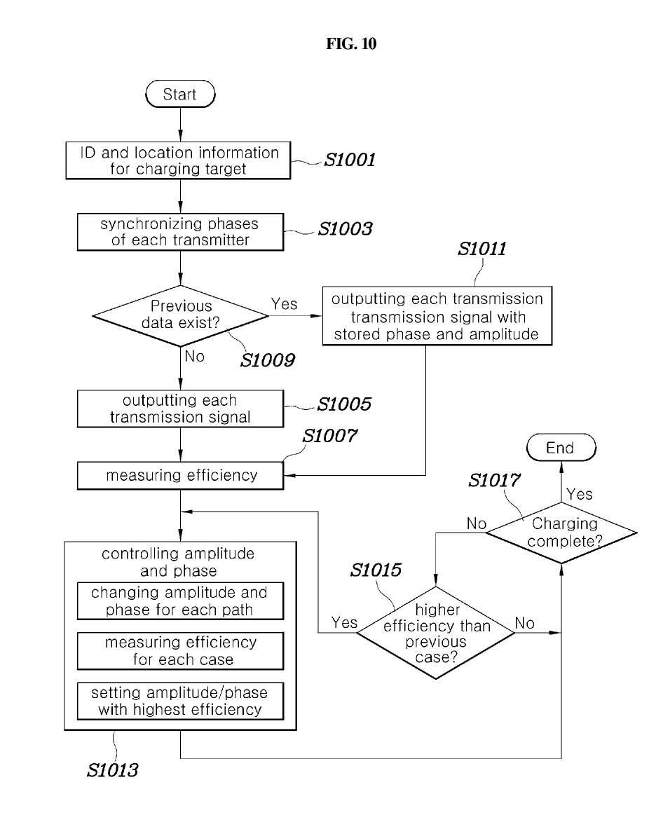

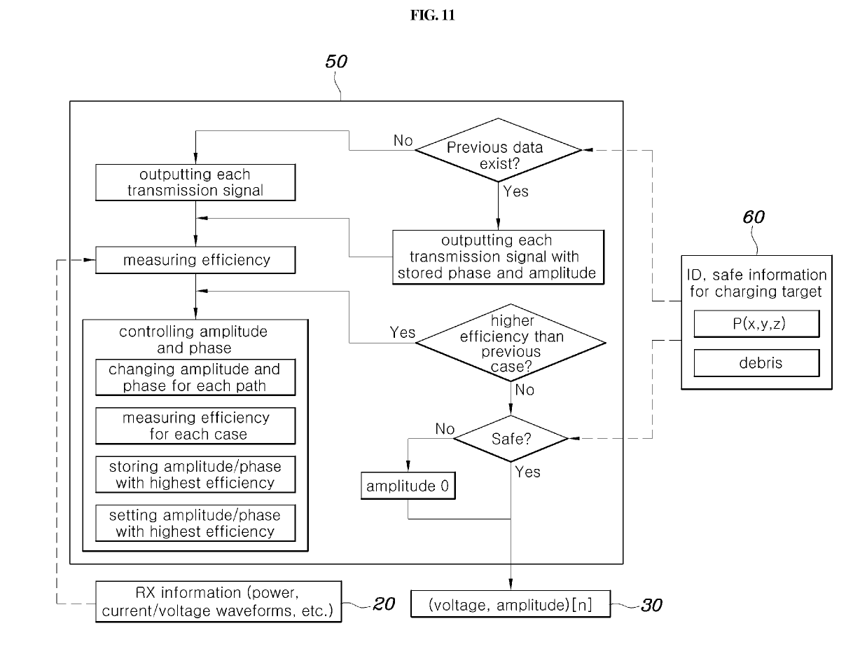

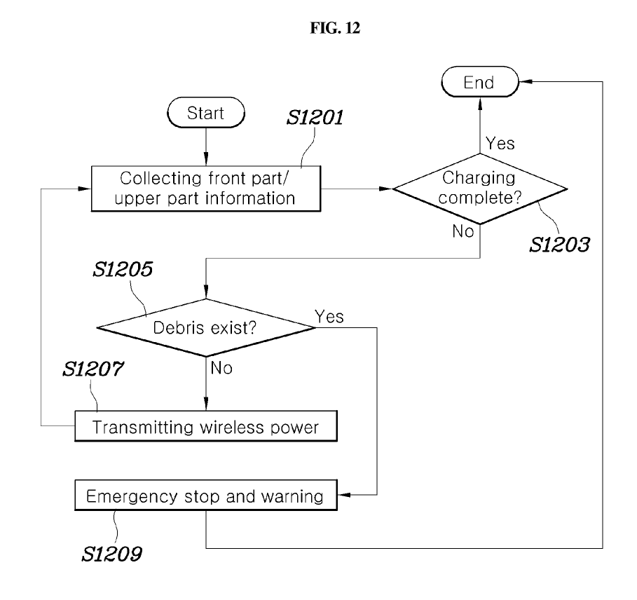

FIG. 10 is an exemplary flow diagram of a controlling method of a power transmission system according to one exemplary embodiment of the present invention, and FIG. 11 is an exemplary block diagram illustrating a relation between components of the power transmission system shown in FIG. 1. FIG. 12 is an exemplary flow diagram of a part of a controlling method of a power transmission system according to one exemplary embodiment of the present invention.

When a vehicle with a receiver pad 20 approaches a transmitter pad 10, the vehicle identification number (ID) and location information may be transmitted to a voltage phase controller 50 disposed on the transmitter pad 10 side (S1001). After phase and amplitude of transmission signals of transmitter coils are matched (S1003), the controller may be configured to determine whether the transmitted vehicle identification number is the same as the previously stored identification number (S1009). When the identification number is the same as the previously stored ID, the amplitude and phase of the transmission signals of respective transmitter coils may be set to the stored phase and amplitude (S1011). When the identification number has not previously been stored, the respective transmission signals of which phases and amplitudes have been matched in a step, S1003, may be output to a receiver coil 22 (S1005).

Furthermore, based on the output transmission signals of which phases and amplitudes are set to the stored phase and amplitude, or the output transmission signals of which phases and amplitudes are matched, power transmission efficiency may be measured at the receiver pad 20 (S1007). When there is power transmission efficiency data measured before adjusting the amplitude and phase of transmission signals, charging may be continued using the transmitted signals when the power transmission efficiency is higher (e.g., greater than a predetermined efficiency). When a voltage phase controller 50 measures power transmission efficiency, the controller may be configured to receive information regarding received power, waveforms of received current and voltage, etc. from the receiver pad 20. When the previously measured power transmission efficiency information does not exist, or it is less than the measured power transmission efficiency at the receiver pad, the power transmission efficiency from the respective transmitter coils may be calculated by increasing or decreasing the phase and amplitude of the transmission signals in the process of measuring power transmission efficiency, and the amplitude and phase with the highest power transmission efficiency may be set (S1013).

Additionally, based on information such as a vehicle identification number (ID) and location, phase and amplitude may be initialized at about 0 degrees and about 50% of maximum value, respectively, as the above example, and then those values may be changed as shown in FIG. 8 to achieve the phase and amplitude with a highest power transmission efficiency. The obtained phase and amplitude belongs to the vehicle, and the height of the vehicle, position of the mounted receiver pad and receiver coil may be different based on the vehicle model. In addition, although vehicles are the same model, each vehicle may have a different impedance condition. Consequently, in the processing of wireless power transmission, the optimized power transmission data for a unique vehicle identification number may be recorded and stored for the next charging. When the phase and amplitude data is accumulated with the charging, the time required to maximize the power transmission efficiency may be decreased by analyzing the accumulated data.

Moreover, before charging a vehicle using transmission signals, the vehicle surroundings may be observed by capturing devices (e.g., imaging devices, sensors, or the like) disposed in a front part and an upper part of the vehicle. The capturing devices may determine whether a person or an animal is around the vehicle, or debris is on the transmitter pad when power is transmitted. The technology using an existing sensor may detect the position of the transmitter pad and coils, but it may be difficult to detect the approach of the debris in real time. However, using the capturing device allows for the possibility of detecting the presence of people, animals, or debris, and thus it may be used for charging.

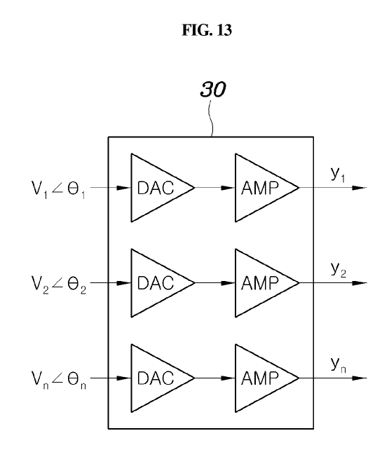

FIG. 13 is an exemplary view plan showing a configuration and input/output of a transmission circuit according to one exemplary embodiment of the present invention. A transmission circuit array 30 may have a converter (DAC) and an amplifier (AMP) that corresponds to each transmitter coil.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A controlling method of a power transmission system, comprising:
matching, by a controller, phases and amplitudes of multiple transmission signals to be output from multiple transmitter coils;
separating, by the controller, the multiple transmission signals of which phases and amplitudes have been matched, and transmitting the separated transmission signals to a receiver coil;
receiving, by the controller, measuring power transmission efficiency of the separated transmission signals; and
adjusting, by the controller, phases and amplitudes of the multiple transmission signals based on the measured power transmission efficiency.

2. The method of claim 1, wherein the matching phases and amplitudes includes:
setting, by the controller, a transmission signal of one transmitter coil among the multiple transmitter coils to a reference signal.

3. The method of claim 2, wherein the matching phases and amplitudes further includes:
extracting, by the controller, a phase difference between transmission signals by calculating cross-correlation between the reference signal and transmission signals of the other transmitter coils.

4. The method of claim 3, wherein the matching phases and amplitudes includes:
matching, by the controller, phases of the transmission signals by adjusting the extracted phase difference.

5. The method of claim 1, wherein the matching phases and amplitudes includes:
transmitting, by the controller, transmission signals from multiple transmitter coils to a receiver coil using carrier signals of different frequencies.

6. The method of claim 5, wherein the matching phases and amplitudes further includes:
extracting, by the controller, a phase difference between transmission signals after removing carrier signals from the signals that have been transmitted to the receiver coil.

7. The method of claim 6, wherein the matching phases and amplitudes includes:
matching, by the controller, phases of the transmission signals by adjusting the extracted phase difference.

8. The method of claim 1, wherein the measuring power transmission efficiency includes:
measuring, by the controller, power transmission efficiency by increasing or decreasing phase and amplitude of a transmission signal transmitted from a respective transmitter coil.

9. The method of claim 8, wherein the adjusting phase and amplitude of the multiple transmission signals includes:
setting, by the controller, the phase and amplitude to a phase and amplitude in which the measured power transmission efficiency is a highest.

10. The method of claim 1, further comprising:
storing, by the controller, the adjusted phase and amplitude and a vehicle identification number that correspond to the phase and amplitude.

11. The method of claim 10, wherein the phase and amplitude of multiple transmission signals are adjusted to a phase and amplitude that correspond to the vehicle identification number when the vehicle identification number is detected and the detected identification number is a stored number.

12. The method of claim 1, further comprising:
observing, by the controller, vehicle surroundings using capturing devices disposed in a front part and an upper part of the vehicle before transmitting transmission signals to a receiver coil.

13. A controlling system of a power transmission system, comprising:
a memory configured to store program instructions; and
a processor configured to execute the program instructions, the program instructions when executed configured to:
match phases and amplitudes of multiple transmission signals to be output from multiple transmitter coils;
separate the multiple transmission signals of which phases and amplitudes have been matched, and transmitting the separated transmission signals to a receiver coil;
measure power transmission efficiency of the separated transmission signals; and
adjust phases and amplitudes of the multiple transmission signals based on the measured power transmission efficiency.

14. The system of claim 13, wherein the program instructions when executed are further configured to set a transmission signal of one transmitter coil among the multiple transmitter coils to a reference signal.

15. The system of claim 14, wherein the program instructions when executed are further configured to extract a phase difference between transmission signals by calculating cross-correlation between the reference signal and transmission signals of the other transmitter coils.

16. The system of claim 15, wherein the program instructions when executed are further configured to match phases of the transmission signals by adjusting the extracted phase difference.

17. A non-transitory computer readable medium containing program instructions executed by a controller, the computer readable medium comprising:
program instructions that match phases and amplitudes of multiple transmission signals to be output from multiple transmitter coils;
program instructions that separate the multiple transmission signals of which phases and amplitudes have been matched, and transmitting the separated transmission signals to a receiver coil;
program instructions that measure power transmission efficiency of the separated transmission signals; and
program instructions that adjust phases and amplitudes of the multiple transmission signals based on the measured power transmission efficiency.

18. The non-transitory computer readable medium of claim 17, further comprising:
program instructions that set a transmission signal of one transmitter coil among the multiple transmitter coils to a reference signal.

19. The non-transitory computer readable medium of claim 18, further comprising:
program instructions that extract a phase difference between transmission signals by calculating cross-correlation between the reference signal and transmission signals of the other transmitter coils.

20. The non-transitory computer readable medium of claim 19, further comprising:
program instructions that match phases of the transmission signals by adjusting the extracted phase difference.
